(19) United States
(12) Patent Application Publication
(10) Pub. No.: US 2025/0333188 A1
(43) Pub. Date: Oct. 30, 2025

(54) WING STRUT MOUNT FOR AIRCRAFT SENSOR POD

(71) Applicant: ROBOTIC SERVICES INC., Daytona Beach, FL (US)

(72) Inventors: Alex Thomas SHIFFER, New Smyrna Beach, FL (US); Nathan Charles SULLIVAN, Daytona Beach, FL (US)

(21) Appl. No.: 19/188,936

(22) Filed: Apr. 24, 2025

Related U.S. Application Data
(60) Provisional application No. 63/638,440, filed on Apr. 25, 2024.

(51) Int. Cl. B64D 47/08

(52) U.S. Cl. CPC B64D 47/08

(57) ABSTRACT

A system and method for mounting a sensor pod for aerial photography is described. In an embodiment, the mount includes features to make it one or more of modular, quick release, adjustable, and toollessly installable. The mount is mountable on a wing strut of an aircraft, and because it does not require tools to install, the Pilot-in-Command (PIC) may install the device without the need for a certified aircraft mechanic to perform the installation.

### CROSS-REFERENCE TO RELATED APPLICATION

This application claims priority to U.S. Provisional Application 63/638,440, filed Apr. 25, 2024, which is incorporated by reference herein.

### FIELD OF INVENTION

This disclosure relates generally to systems for mounting cameras. More particularly, it relates to camera mounting systems for aircraft that include structures facilitating simplified mounting and adjustability.

### BACKGROUND

Aerial photography and related aerial sensor scanning is scanning from an aircraft or other airborne platforms to collect data, typically looking down. This is also known as taking pictures or other sensor scanning from a birds-eye view, usually collecting images or other data of landscapes or other surface objects.

To contain and manage the sensor systems for aerial photography, sensor enclosers that can be securely attached to the aircraft or airborne platform are employed. There are several issues involved in such platforms: handling wind, vibration, securing the system to the platform itself, and securing and controlling the sensors themselves within the enclosure.

Aerial photography from a crewed aircraft is strictly regulated by the FAA. There are two broad categories for affixing a camera or any sensors to an aircraft with tools and without. Avoidance of the use of tools simplifies the process because it avoids the requirement of installation by a certified Airframe and Powerplant mechanic and the associated paperwork requirements.

### BRIEF SUMMARY OF INVENTION

In an embodiment, a wing strut mount includes an upper section having an interior contour configured to engage a strut of an aircraft on a top side thereof, a lower section, connected to the upper section by a hinge at a first edge of the strut mount, and having a respective interior contour configured to engage the strut on a bottom side thereof, a pin, threaded through knuckles of the hinge, such that the upper section and the lower section are rotatable about the pin, a plurality of fasteners, threadably connecting the upper section and the lower section at a second edge of the strut mount, opposed to the first edge, wherein the fasteners are configured to be hand-tightenable, wherein the lower section further comprises a payload joint, configured and arranged to removably support a payload.

In an embodiment, a method of installing a wing strut mount includes clamping a hingedly connected upper section and lower section around a strut using a plurality of hand-tightenable fasteners.

### BRIEF DESCRIPTION OF DRAWINGS

FIG. 1. is a right rear perspective view of an example wing strut mounting bracket in an open configuration according to various embodiments of the present invention.

FIG. 2. is a right rear perspective view of an example wing strut mounting bracket in a closed configuration according to various embodiments of the present invention.

FIG. 3. is a right perspective view of an example wing strut mounting bracket in a closed configuration according to various embodiments of the present invention.

FIG. 4. is a right perspective view of an example wing strut mounting bracket in an open configuration according to various embodiments of the present invention.

FIG. 5. is a top front right perspective view of an example wing strut mounting bracket in an open configuration according to various embodiments of the present invention.

FIG. 6. is a top front left perspective view of an example wing strut mounting bracket in an open configuration according to various embodiments of the present invention.

FIG. 7. is a bottom rear right perspective view of an example wing strut mounting bracket in a closed configuration according to various embodiments of the present invention.

FIG. 8. is a top rear right perspective view of an example wing strut mounting bracket in a closed configuration according to various embodiments of the present invention.

FIG. 9. is a top front right perspective view of an example wing strut mounting bracket in a closed configuration according to various embodiments of the present invention.

FIG. 10. is a top front left perspective view of an example wing strut mounting bracket in a closed configuration according to various embodiments of the present invention.

FIG. 11. is a rear section perspective view of an example wing strut mounting bracket in a closed configuration according to various embodiments of the present invention. This section view highlights the threaded heat-set inserts installed into the strut mount bottom and thumb screws.

FIG. 12. is a top front right perspective view of an example wing strut mounting bracket in a closed configuration with an example sensor enclosure fuselage installed according to various embodiments of the present invention.

FIG. 13 is a front perspective view of an example wing strut mounting bracket in a closed configuration with an example sensor enclosure fuselage installed at an oblique orientation according to various embodiments of the present invention.

FIG. 14. is a right perspective view of an example wing strut mounting bracket in a closed configuration with foam installed according to various embodiments of the present invention.

FIG. 15. is a top front right perspective view of an example wing strut mounting bracket in an open configuration with foam installed according to various embodiments of the present invention.

FIG. 16. is a front right perspective view of an example wing strut mounting bracket in a closed configuration installed onto a display stand according to various embodiments of the present invention.

### DETAILED DESCRIPTION OF THE INVENTION

A wing strut mount is a device that affixes a sensor payload enclosure to the wing strut of a small aircraft (e.g., Cessna 172 Skyhawk). While this disclosure relates primarily to a Cessna 172 Skyhawk, it should be understood that the principles can be applied to other types of manned and unmanned aircraft.

A strut mount 10 in accordance with an embodiment features a design and hardware that may allow the user to install it to the wing strut of the aircraft without tools. The ability to install the mount without tools can enable the Pilot-in-Command (PIC), for example, to install the device without the need for a certified aircraft mechanic to perform the installation.

The design of strut mount 10 may streamline the installation process by providing quick-release pins and thumb screws. The mounting interface on the bottom of the wing strut mount 10 can enable the user to install the mount and sensor enclosure to either side of the aircraft with an adjustable orientation angle.

In an embodiment, the top 16 and bottom sections 18 are attached through a hinge-like joint at the front using a locking quick-release pin 12. During installation, the top and bottom sections are secured around the aircraft's wing strut by fasteners 20, which may be, for example, spade-headed thumb screws that can be hand-tightened. In an embodiment, a through hole in each thumb screw allows for the installation of a safety pin 26 through adjacent pairs of screws (Left and Right). This safety pin ensures that the thumb screws do not become loose during flight.

In an embodiment, the top and bottom sections 16, 18 may be made from a glass fiber reinforced nylon material. As will be appreciated, they may be molded, or made by an additive manufacturing process.

The inventors have found that it is useful to aircraft operations to provide a device that allows the aircraft crew to avoid the need for an FAA certified mechanic. In view of relevant regulations, this means that the device should be able to be installed without the use of tools. Therefore, in an embodiment, the design of the aircraft wing strut mounting bracket allows for hand-secured attachment.

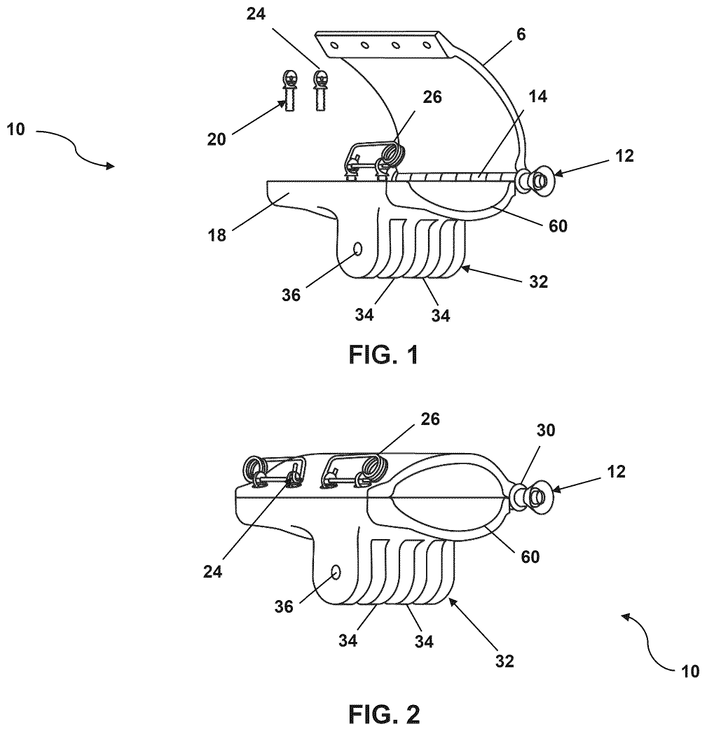

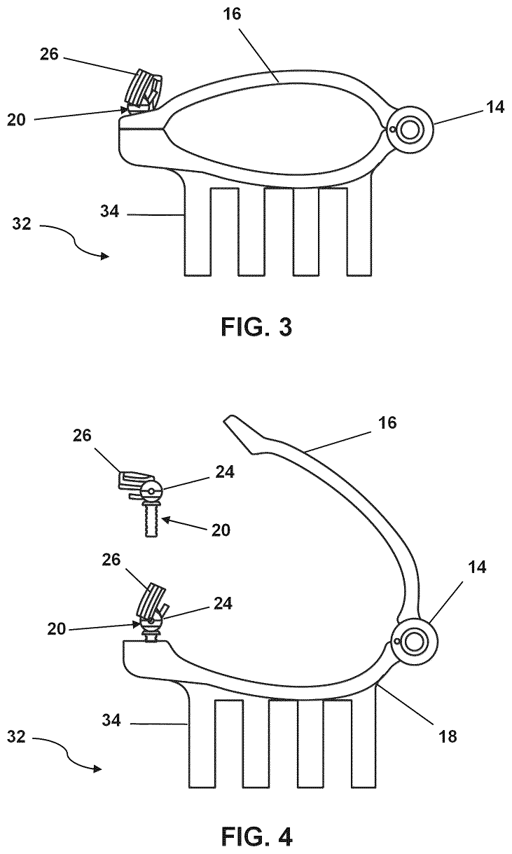

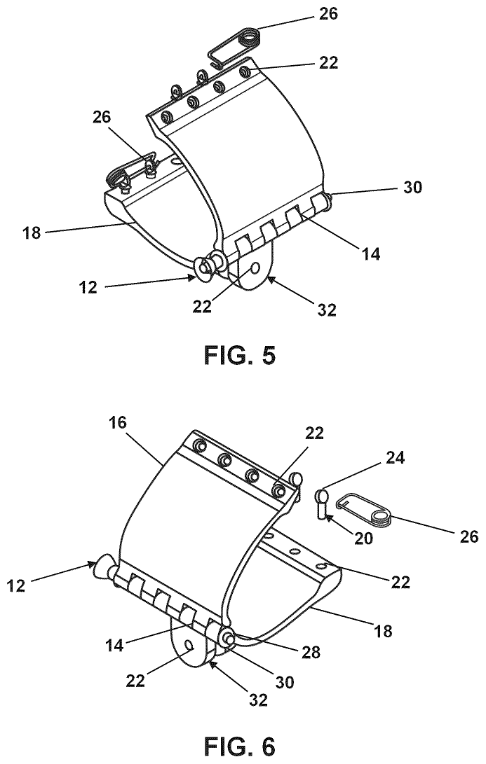

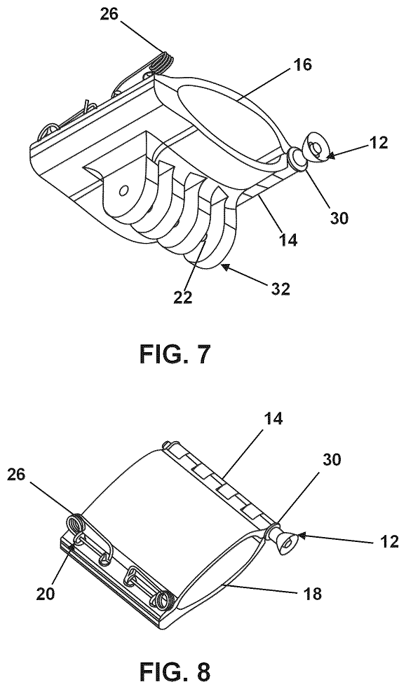

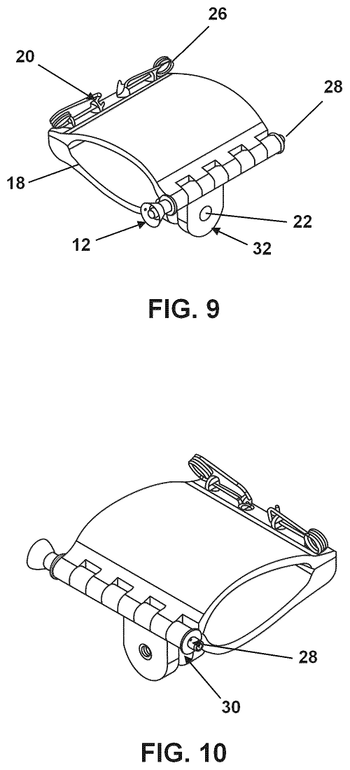

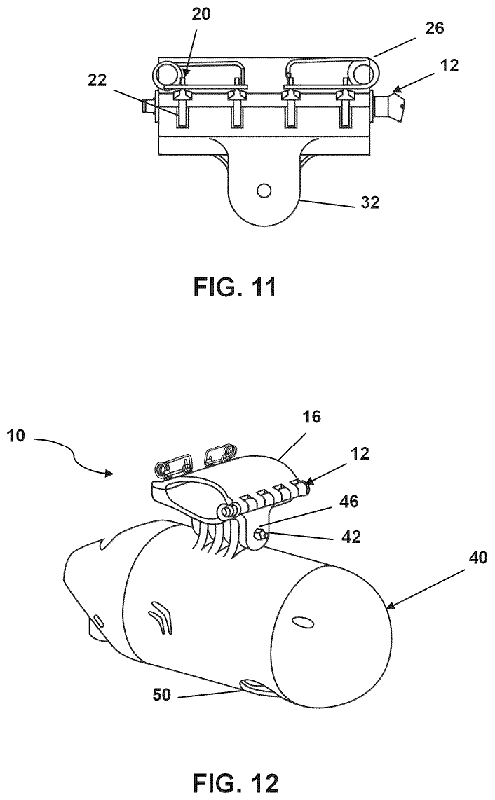

Referring now to FIG. 1, a locking quick-release pin 12 may be installed through the leading-edge hinge joint 14. The quick-release pin 12 secures the strut mount 10 top portion 16 and bottom portion 18 together. The trailing edge of the strut mount 10 may be secured using fasteners 20, which may be, for example, thumb screws. The fasteners 20 engage with threaded heat-set inserts 22 and compress the strut mount top 16 to the strut mount bottom 18.

In an embodiment, the fasteners 20 may be thumb screws that include a hole drilled through the spade head 24 allowing for the installation of a safety pin 26. In this approach, each pair of thumb screws may be pinned together (as seen in FIG. 2) to secure them and prevent loosening during flight operations. A hand-tight fastener installed without tools may be subject to torques in the range of 0.05-0.4 Nm and more particularly in the range of 0.2-0.3 Nm.

Finally, the strut mounting bracket 10 may include load-distributing retaining washer(s) 30 on the quick-release pin 12. This can help ensure that locking bearings 28 of the quick-release pin 12 solidly contact a material with a hardness greater than that of the material from which the top 16 and bottom 18 portions of the strut mount are made.

The strut mount 10 may further include a rotational payload knuckle joint 32. In an embodiment, this joint 32 can be made from a plurality of connecting portions 34 extending away from the main body of the strut mount 10. Each flat portion may include a respective through hole 36, and the through holes 36 may be aligned along a common axis. These through holes may also include threaded heat-set inserts, similar to those used for the fasteners 20.

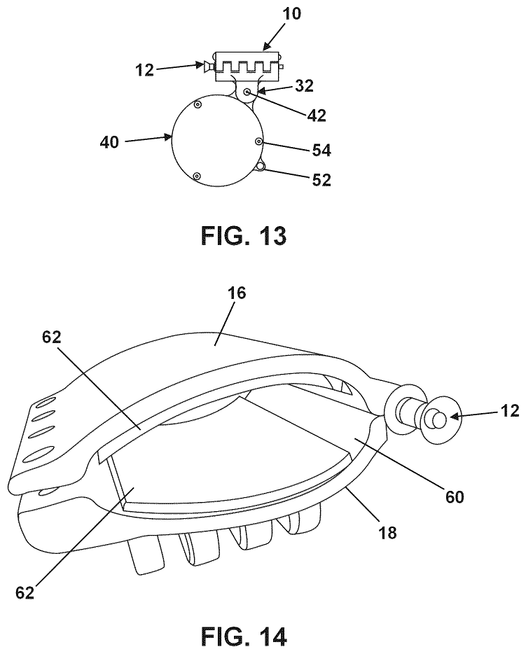

The rotational payload knuckle joint 32 may allow an operator to modify the orientation of a sensor payload 40 (best seen in FIGS. 12 and 13). A locking pin 42 may be placed through the holes 34 to connect the corresponding tabs 44 of the sensor payload 40 to the connecting portions 34 of the strut mount 10. This locking pin 42 can allow for rotation of the sensor payload 40 about the longitudinal axis of the knuckle joint 32. As will be appreciated, among other aspects, this design feature can allow for the strut mount 10 to be mounted on either a left- or right-wing strut.

In an embodiment, once rotated to a selected orientation, the configuration can be secured using a screw and corresponding threaded heat-set insert that is installed into the front knuckle of the strut mount bottom 18. In an embodiment, this may be a ⅜ in. (˜9.5 mm) screw. The screw may be tightened sufficiently to clamp the knuckles together to provide sufficient friction to prohibit rotation under normal loads. In an embodiment, a lock nut 46 such as a nylon lock nut, best seen in FIG. 12, is installed onto the screw to act as a jam nut to prevent the screw from loosening.

As will be appreciated, the sensor pod 40 may include one or more of various types of sensors. Such sensors that are suited to this application include digital or analog cameras, lidar, radar (microwave or millimeter wave), sonar, infrared cameras, and the like.

Using the attachment mechanism as described above, the wing strut sensor mount 10 may allow the sensor pod 40 to be positioned by rotation, thereby allowing the wing strut mount 10 to work on either a left-side aircraft wing strut or a right-side aircraft wing strut. The precise positioning of the sensor pod rotation is selected to allow for line of sight from the sensor pod bottom aperture or lens 50 to the ground. A pod sensor calibration process may be used to orient and align the sensors in a separate step. Optionally, the sensor pod 40 may include a GPS antenna boom sleeve 52, and one or more nose section mounting screws 54.

The hinge connection between the top and bottom sections 16, 18 may allow for a stable and consistent relationship between the two parts. Moreover, opening and closing of the top and bottom sections 16, 18 can be performed while maintaining relative alignment between the two parts.

The strut mount 10 has an interior contour 60 that is selected in advance to conform substantially to the shape of the strut of the aircraft to which it is intended to be mounted. As will be appreciated, this shape does not need to exactly form fit, but a general conformity allows for stable mounting.

Moreover, the interior contour 60 may be selected to be slightly offset from the shape of the strut to which it is to be mounted. In this approach, a pad 62 made from a compressible material may be included on the interior contour surface that engages the strut. Appropriate compressible materials may include polyurethane, polyurethane foam, natural or synthetic rubber (SBR, EPDM, for example), silicone, or other elastomeric materials. It may be adhered to the interior contour 60 by use of an acrylic adhesive, for example. This compressible material can act both to help secure the mount in position and to protect the surface itself from being damaged by the mount. Moreover, in the case that strut sizes vary due to manufacturing variability, the use of a compressible layer helps to allow for such variation.

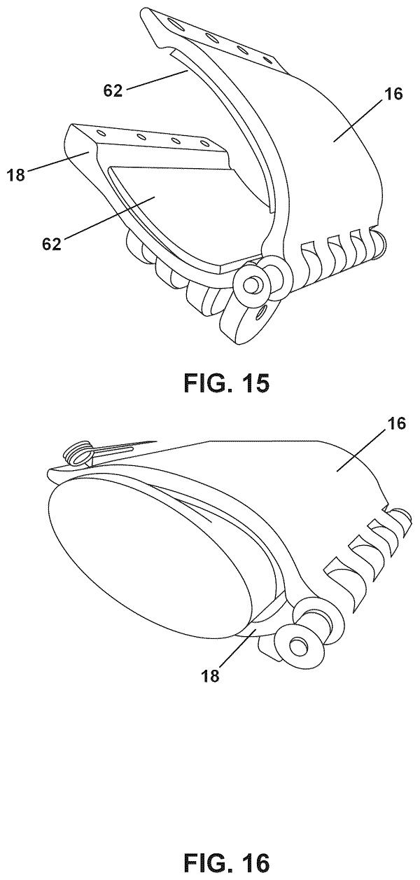

In an embodiment, best seen in FIGS. 14-16, a respective pad 62 may be affixed to the top 16 and bottom section 18. The foam material may further allow for precise compression when closed for a stable and firm grip, and can allow for reduction of transmission of vibrations to the sensor pod 40. As described above, hand tightening of the fasteners 20 acts to compress the pad 62.

In an embodiment, the mounting system may be one or all of modular, quick release, adjustable, and/or toollessly mountable and positionable.

In an aspect, an aircraft wing strut mounting bracket is designed to be hand secured utilizing a locking quick-release pin installed through the leading-edge hinge joint which secures the strut mount top and bottom together. It is configured with thumb screws into threaded heat-set inserts compressing the strut mount top to the strut mount bottom, and with a hole drilled through the spade head of the thumb screws configured to allow for the installation of a safety pin ensuring the mount does not become loose during flight.

In an aspect, a strut mounting bracket with a load-distributing retaining washers on a quick-release pin is configured to ensure that the locking ball bearings are in contact with a material with a hardness greater than that of the glass fiber infused nylon filament used to manufacture the mounting bracket.

In an aspect, a rotational payload knuckle joint portion of the wing strut mount is configured to let the user modify the orientation of the sensor payload.

In an aspect, an adjustable payload joint attachment of the wing strut mount to the sensor enclosure fuselage includes a screw that secures the connection and orientation using friction, secured with a threaded heat-set insert on the front knuckle of the adjustable payload joint in the wing strut mount, and is configured with a lock nut as a jam nut against the heat-set knuckle.

In an aspect, a hinged wing strut mounting bracket includes a compressible pad which may be, for example, polyurethane affixed to the top and bottom providing precise compression and a stable and firm grip with hand tightened pins, locked with safety pins, and is configured to handle vibrations in flight operations.

The reader should appreciate that the present application describes several inventions. Rather than separating those inventions into multiple isolated patent applications, applicants have grouped these inventions into a single document because their related subject matter lends itself to economies in the application process. But the distinct advantages and aspects of such inventions should not be conflated. In some cases, embodiments address all of the deficiencies noted herein, but it should be understood that the inventions are independently useful, and some embodiments address only a subset of such problems or offer other, unmentioned benefits that will be apparent to those of skill in the art reviewing the present disclosure. Due to cost constraints, some inventions disclosed herein may not be presently claimed and may be claimed in later filings, such as continuation applications or by amending the present claims. Similarly, due to space constraints, neither the Abstract nor the Summary of the Invention sections of the present document should be taken as containing a comprehensive listing of all such inventions or all aspects of such inventions.

It should be understood that the description and the drawings are not intended to limit the invention to the particular form disclosed, but to the contrary, the intention is to cover all modifications, equivalents, and alternatives falling within the spirit and scope of the present invention as defined by the appended claims. Further modifications and alternative embodiments of various aspects of the invention will be apparent to those skilled in the art in view of this description. Accordingly, this description and the drawings are to be construed as illustrative only and are for the purpose of teaching those skilled in the art the general manner of carrying out the invention. It is to be understood that the forms of the invention shown and described herein are to be taken as examples of embodiments. Elements and materials may be substituted for those illustrated and described herein, parts and processes may be reversed or omitted, and certain features of the invention may be utilized independently, all as would be apparent to one skilled in the art after having the benefit of this description of the invention. Changes may be made in the elements described herein without departing from the spirit and scope of the invention as described in the following claims. Headings used herein are for organizational purposes only and are not meant to be used to limit the scope of the description.

As used throughout this application, the word “may” is used in a permissive sense (i.e., meaning having the potential to), rather than the mandatory sense (i.e., meaning must). The words “include”, “including”, and “includes” and the like mean including, but not limited to. As used throughout this application, the singular forms “a,” “an,” and “the” include plural referents unless the content explicitly indicates otherwise. Thus, for example, reference to “an element” or “a element” includes a combination of two or more elements, notwithstanding use of other terms and phrases for one or more elements, such as “one or more.” The term “or” is, unless indicated otherwise, non-exclusive, i.e., encompassing both “and” and “or.” Unless otherwise indicated, statements that “each” instance of some collection have some property should not be read to exclude cases where some otherwise identical or similar members of a larger collection do not have the property, i.e., each does not necessarily mean each and every.

What is claimed is:

1. A hand-installable strut mount, comprising:
an upper section having an interior contour configured to engage a strut of an aircraft on a top side thereof;
a lower section, connected to the upper section by a hinge at a first edge of the strut mount, and having a respective interior contour configured to engage the strut on a bottom side thereof;
a pin, threaded through knuckles of the hinge, such that the upper section and the lower section are rotatable about the pin;
a plurality of fasteners, threadably connecting the upper section and the lower section at a second edge of the strut mount, opposed to the first edge, wherein the fasteners are configured to be hand-tightenable;
wherein the lower section further comprises a payload joint, configured and arranged to removably support a payload.

2. The strut mount of claim 1, wherein the pin is a quick-release pin.

3. The strut mount of claim 1, further comprising a retaining washer positioned between the hinge and a head of the pin such that force applied by the head of the pin is distributed over an area of an edge of the hinge.

4. The strut mount of claim 1, wherein the plurality of fasteners comprise thumb-screws, and wherein each thumb-screw includes a flat head portion having a respective hole therethrough for receiving a safety pin configured to interconnect adjacent ones of the thumb-screws to secure them from loosening.

5. The strut mount of claim 1, wherein the payload joint comprises a plurality of tabs each having a hole therethrough and configured and arranged to engage cooperating tabs of the payload, the cooperating tabs having respective holes therethrough.

6. The strut mount of claim 5, wherein the tabs of the strut mount and the cooperating tabs of the payload are configured to allow relative rotation between the strut mount and the payload.

7. The strut mount of claim 6, further comprising a screw extending through holes of the tabs of the payload joint and the cooperating tabs of the payload, the screw being hand-tightenable to secure the payload and to limit the relative rotation between the strut mount and the payload.

8. The strut mount of claim 7, further comprising a locking nut engaging the screw to secure it in place.

9. The strut mount of claim 1, wherein at least one of the interior contour of the upper section and the interior contour of the lower section comprises a compressible pad.

10. The strut mount of claim 9, wherein each of the interior contour of the upper section and the interior contour of the lower section comprises a respective compressible pad.

11. The strut mount of claim 1, wherein the first edge is a leading edge and the second edge is a trailing edge when the strut mount is installed on an aircraft.
